(19) United States
(12) Patent Application Publication
(10) Pub. No.: US 2026/0245754 A1
(43) Pub. Date: Aug. 20, 2026

(54) METAL-ORGANIC FRAMEWORK COATINGS FOR USE IN A NUCLEAR REACTOR SYSTEM

(71) Applicant: ABILENE CHRISTIAN UNIVERSITY, Abilene, TX (US)

(72) Inventors: Kim Pamplin, Abilene, TX (US); Diego Zometa, Abilene, TX (US); Victoriano Cooper, Abilene, TX (US); Aaron Robison, Abilene, TX (US)

(21) Appl. No.: 19/543,393

(22) Filed: Feb. 18, 2026

Related U.S. Application Data
(60) Provisional application No. 63/760,412, filed on Feb. 19, 2025.

(51) Int. Cl. G21C 19/303; G21C 3/54

(52) U.S. Cl. CPC G21C 19/303; G21C 3/54

(57) ABSTRACT

A metal-organic framework coating may be employed in a molten salt reactor system to capture gaseous fission products produced as a consequence of operation. The metal-organic framework coating may include one or more metal-organic frameworks configured to capture certain fission products based on the need, for example tritium fluoride, tritium gas, and hydrogen fluoride. The one or more metal-organic frameworks may be immobilized onto a substrate and formed into a coating covering the substrate. In many cases, the substrate is the stainless-steel surfaces of reactor enclosures and vessels. In other cases, the substrate may be suspended into a headspace of a vessel of a salt-bearing component, or may be included in an off-gas processing system of a reactor system.

### CROSS REFERENCE TO RELATED APPLICATIONS

This application relates and claims priority to U.S. Provisional Application No. 63/760,412, filed Feb. 19, 2025, and entitled “METAL-ORGANIC FRAMEWORK COMPOSITES FOR USE IN A NUCLEAR REACTOR SYSTEM,” which is hereby incorporated by reference in its entirety.

### TECHNICAL FIELD

The described examples relate generally to systems and methods for use of metal-organic framework coatings in reactors systems, and in particular, to systems and methods for capturing fission product gases from a nuclear reactor system.

### BACKGROUND

Molten salt reactors (MSRs) offer an approach to nuclear power that utilizes a molten salt as a carrier for nuclear fuel (e.g., uranium) in place of the conventional solid fuels used in light water reactors. Molten fuel salt compositions may include LiF—BeF₂—UF₄. Advantages include efficient fuel utilization and enhanced safety (largely due to replacing water as a coolant with molten salt). In an MSR, fission reactions occur within a molten salt composition housed within a reactor vessel generating a thermal output. Tritium is produced as a nuclear product of the fission reactions within the molten fuel salt. Tritium may be present in MSR systems as a gas in the form of diatomic tritium (“T₂” or “³H₂”) or tritium fluoride (“TF”), both of which are known to diffuse or otherwise pass through stainless steel, a common material for use in nuclear reactor systems. It is anticipated that molten fuel salts within a reactor system will produce approximately 1.5 Ci of tritium per megawatt day. Assuming a reactor lifespan of about 5 years of constant operations, operators may need to anticipate handling about 6×10²² atoms of tritium or about 0.1 moles of tritium. Among a variety of hazards, tritium may invade the water cycle due to its ability to incorporate into water molecules that may then be ingested presenting a grave health risk. Additionally, the presence of T₂ and TF may be problematic in an MSR system due to its corrosive properties and for its potential to reduce the power output of the reactor system. However, tritium compounds often evade capture by diffusion through stainless steel. As such, there is a need for systems and techniques for capturing tritium compounds in a nuclear reactor system, particularly to avoid permeation through stainless steel enclosures.

### SUMMARY

In one example, a fission gas capture system for a nuclear reactor is disclosed. The fission gas capture system includes a nuclear reactor system including at least one enclosure vessel. The nuclear reactor system is configured to cause fission reactions and release fission product gases within the enclosure vessel. The fission gas capture system further includes a metal-organic framework (“MOF”) composite disposed in at least one enclosure vessel. The metal-organic framework composite is configured to capture fission products.

In another example, the metal-organic framework composite is a coating disposed over at least a portion of an inner surface of at least one enclosure vessel.

In another example, the coating is a malleable clay configured to withstand temperatures at least 500° C.

In another example, the fission products comprise tritium-containing gases.

In another example, the metal-organic framework composite includes at least one metal-organic framework immobilized in a solid substrate.

In another example, the metal-organic framework comprises zeolitic imidazolate framework 8 (ZIF-8) and the substrate comprises magnesium carbonate.

In another example, at least one enclosure vessel is an outer reactor enclosure vessel surrounding salt-bearing components of the nuclear reactor system.

In another example, at least one enclosure vessel is an internal shielding vessel surrounding a reactor vessel and a drain tank.

In another example, the metal-organic framework composite is disposed in at least two enclosure vessels.

In another example, the fission gas capture system further includes a suspension assembly configured to suspend the metal-organic framework composite in a vessel.

In another example, the suspension assembly includes an attachment rod coupled to the metal-organic framework composite and extending into a headspace of the vessel. The suspension assembly further includes a salt barrier positioned at an upper portion of the removeable attachment rod. The suspension assembly further includes a housing extending from the reactor access vessel encompassing the suspension assembly. The suspension assembly further includes a valve operable to enable passage of the attachment rod into and out of the housing.

In one example a vessel is disclosed. The vessel includes an enclosure defining an inner volume and including an inner surface facing the inner volume. The vessel further includes a malleable clay disposed over at least a portion of the inner surface. The malleable clay is configured to capture fission products within the inner volume.

In another example, the malleable clay includes a metal-organic framework composite.

In another example, the metal-organic framework composite includes at least one metal-organic framework and a substrate.

In another example, at least one metal-organic framework includes zeolitic imidazolate framework 8 (ZIF-8) and the substrate includes magnesium carbonate.

In another example, the enclosure encompasses at least one salt-bearing component of a molten salt reactor system.

In another example, at least one salt-bearing component includes a reactor vessel including a reactor core, a drain tank configured to store a molten salt, a primary heat exchanger operable to facilitate heat transfer of the molten salt to a secondary salt, and/or a reactor access vessel.

In yet another example, the vessel further includes an internal shielding vessel disposed within the inner volume encompassing at least the reactor vessel and the drain tank. The malleable clay is disposed over at least a portion of an inner surface of the internal shielding vessel.

In one example, an off-gas system is disclosed. The off-gas system includes an off-gas inlet configured to receive an off-gas from a nuclear reactor system. The off-gas includes fission products. The off-gas system further includes a first tank configured to receive the off-gas and comprising a metal-organic framework composite. The off-gas system further includes a second tank configured to receive the off-gas and comprising at least one charcoal bed. The metal-organic framework composite is configured to capture the fission products.

In another example, the metal-organic framework composite includes at least one metal-organic framework immobilized into a solid substrate.

In another example, at least one metal-organic framework is configured to capture tritium-containing gases.

In yet another example, the metal-organic framework includes zeolitic imidazolate framework 8 (ZIF-8) and the substrate includes magnesium carbonate.

In one example, a method of operating a nuclear reactor is disclosed. The method includes generating fission product gases by operating a molten salt reactor system. The salt-bearing components of the molten salt reactor systems are enclosed within a reactor enclosure at least partially coated with a metal-organic framework composite. The method further includes capturing fission product gases via the metal-organic framework composite.

In another example, the metal-organic framework composite includes a metal-organic framework configured to capture hydrogen fluoride and/or tritium fluoride bound to a substrate.

In another example, the metal-organic framework composite is coated on at least a portion of an inner surface of the reactor enclosure.

In yet another example, the method further includes comprising removing the metal-organic framework composite after the capturing, thereby removing captured fission product gases from the nuclear reactor.

In one example, a fission gas capture system for a nuclear reactor is disclosed. The fission gas capture system includes a nuclear reactor system including at least one enclosure vessel. The nuclear reactor system is operable to generate thermal energy via fission reactions. The fission reactions generate gaseous fission products. The fission gas capture system includes a metal-organic framework coating disposed on a surface of the at least one enclosure vessel. The metal-organic framework coating is configured to capture the gaseous fission products.

In another example, the metal-organic framework coating is immobilized on the surface via ligand anchoring.

In another example, the metal-organic framework coating includes at least one metal-organic framework selected from the group consisting of ZIF-4, ZIF-8, and UiO-66.

In another example, the metal-organic framework coating is immobilized to the surface by deprotonating ligands of the metal-organic framework, dissolving the deprotonated metal-organic framework in a volatile solvent, oxidizing a surface of the at least one enclosure vessel, and drying the metal-organic framework on the surface

In another example, the gaseous fission products comprise tritium.

In another example, the metal-organic framework coating includes at least one zeolitic imidazolate framework.

In another example, the at least one enclosure vessel is an outer reactor enclosure vessel surrounding salt-bearing components of the nuclear reactor system.

In another example, the at least one enclosure vessel is an internal shielding vessel surrounding a reactor vessel and a drain tank.

In another example, the at least one enclosure vessel includes one or more distinct layers.

In another example, the fission gas capture system further includes a suspension assembly coupled to a salt-bearing vessel of the nuclear reactor system operable to suspend a cartridge containing the metal-organic framework coating in the salt-bearing vessel.

In yet another example, the suspension assembly includes an attachment rod coupled to the cartridge and extending into a headspace of the vessel. The suspension assembly further includes a housing extending from the reactor access vessel encompassing the suspension assembly and an actuator operable to lower the cartridge into the headspace.

In one example, a reactor enclosure is disclosed. The reactor enclosure includes an enclosure vessel defining an inner volume and including one or more layers. The inner volume is configured to house one or more salt-bearing components of a molten salt reactor system. The reactor enclosure further includes a metal-organic framework coating disposed over at least a portion of a surface of the one or more layers. The metal-organic framework coating is configured to capture fission product gases.

In another example, the metal-organic framework coating includes at least one metal-organic framework selected from the group consisting of ZIF-4, ZIF-8, and UiO-66.

In another example, the metal-organic framework coating is immobilized on a metallic portion of the one or more layers via ligand anchoring between the at least one metal-organic framework and the metallic portion.

In another example, the at least one metal-organic framework includes deprotonated ligands.

In another example, the enclosure encompasses the at least one salt-bearing component of the molten salt reactor system.

In another example, the at least one salt-bearing component includes a reactor vessel including a reactor core, a drain tank configured to store a molten salt, a primary heat exchanger operable to facilitate heat transfer of the molten salt to a secondary salt, and a reactor access vessel.

In yet another example, the vessel further includes an internal shielding vessel disposed within the inner volume encompassing at least the reactor vessel and the drain tank.

In one example, an off-gas system is disclosed. The off-gas system includes an off-gas inlet pipe configured to receive an off-gas from a nuclear reactor system. The off-gas includes fission products. The off-gas system further includes a first tank coupled to the off-gas inlet and configured to receive the off-gas. The off-gas system further includes a second tank coupled to the first tank and configured to receive the off-gas from the first tank. The off-gas system further includes an isotope trap arranged within the first tank. The off-gas system further includes at least one charcoal bed arranged within the second tank. The isotope trap includes at least one metal-organic framework configured to capture the fission products.

In another example, the off-isotope trap further includes a substrate. The at least one metal-organic framework is immobilized onto the substrate.

In another example, the at least one metal-organic framework is configured to capture tritium.

In yet another example, the metal-organic framework is selected from the group consisting of ZIF-8, ZIF-4, and UiO-66.

In one example, a method of operating a nuclear reactor is disclosed. The method includes generating fission product gases by operating a molten salt reactor system. The salt-bearing components of the molten salt reactor systems are enclosed within a reactor enclosure at least partially coated with a metal-organic framework coating. The method further includes capturing the fission product gases via the metal-organic framework coating.

In another example, the metal-organic framework coating is configured to capture hydrogen fluoride and tritium fluoride.

In another example, the metal-organic framework coating is disposed on at least a portion of a surface of the reactor enclosure.

In yet another example, the method further includes removing the metal-organic framework coating after the capturing, thereby removing captured fission product gases from the nuclear reactor.

### BRIEF DESCRIPTION OF THE DRAWINGS

FIG. 1 illustrates an example molten salt reactor system.

FIG. 2 illustrates an isometric and semi-transparent view of an example molten salt reactor system.

FIG. 3 illustrates a cross-sectional view of an example reactor enclosure.

FIG. 4 illustrates a cross-sectional view of an example internal shielding vessel.

FIG. 5A illustrates an example metal-organic framework coating.

FIG. 5B illustrates another example metal-organic framework coating.

FIG. 6 illustrates a detailed view of an example configuration of a metal-organic framework coating on an enclosure vessel.

FIG. 7 illustrates an example suspension assembly.

FIG. 8 illustrates an example off-gas system.

FIG. 9A illustrates a molecular structure of an example metal-organic framework.

FIG. 9B illustrates a molecular structure of another example metal-organic framework.

FIG. 9C illustrates a molecular structure of yet another example metal-organic framework.

FIG. 10 illustrates a simplified synthesis scheme for a metal-organic framework composite.

FIG. 11 illustrates a simplified scheme for immobilizing the MOF coating onto a substrate.

FIG. 12 illustrates a flow diagram of an example method for capturing fission product gases with a metal-organic framework coating.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various embodiments of the present invention. However, it should be understood that the described disclosure may be practiced in a variety of forms in addition to those described herein.

The following disclosure relates generally to systems, devices, and techniques for capturing gaseous fission products produced as a consequence of the operation of a nuclear reactor system. Molten salt reactors (MSRs) may cause or facilitate fission reactions of fissile material dissolved within a molten salt to produce heat and ultimately power. For example, uranium dissolved in LiF—BeF₂ salt (collectively “molten fuel salt”) may undergo fission reaction within a reactor core of an MSR. As a result of such fission reactions, a wide variety of fission products are produced, either directly or indirectly. As a nonlimiting example, tritium may be produced as a by-product of irradiating the molten fuel salt via neutron reaction with Li-6 and Be-9 (potentially uncommon but present isotopes within the molten fuel salt). In many cases the tritium is present in a gaseous phase as diatomic tritium (“T₂” or “³H₂”) or tritium fluoride (“TF”) and may migrate throughout the MSR system. Operators will need to anticipate tritium production in molten salt reactor design, both for regulatory and safety reasons. As an example, molten fuel salts within an operating reactor system are anticipated to produce about 1.5 Ci of tritium per megawatt day. Consequently, the presence of tritium may increase as the reactor system operates. As another nonlimiting example, hydrogen fluoride (“HF”) may be produced as a by-product of irradiation of the molten fuel salt.

It is advantageous to remove tritium from an MSR system. Tritium in the form of TF (and HF in general) is a highly reactive and toxic molecule that can be corrosive and damaging to components of the MSR system. Among a variety of hazards, tritium may invade the water cycle due to its ability to incorporate into water molecules that may then be ingested presenting a grave health risk. Additionally, the presence of tritium within the MSR system may impede the maximum power production of the system, thus its capture allows operators to eventually increase the power output of the reactor. Furthermore, tritium is radioactive and decays into helium-3 (a potential fuel for nuclear fusion). However, tritium gases can elude conventional approaches of containment and capture. For example, typical reactor vessels and enclosures utilize stainless steel to contain the molten fuel salt and shield the environment. However, tritium is known to penetrate, diffuse, or otherwise pass through stainless steel. As another example, conventional off-gas purification systems utilize a charcoal bed, which may become corroded or defective when exposed to TF and HF.

To mitigate these and other challenges, the systems, devices, and techniques of the present disclosure include a sorbent (e.g., adsorbent and/or absorbent material) coating disposed within the reactor system and configured to capture fission product gases, such as tritium gas, tritium fluoride gas, and hydrogen fluoride gas. The sorbent coating may accomplish the foregoing functionality by comprising one or more metal-organic frameworks configured to adsorb, absorb, neutralize, or otherwise capture fission product gases (e.g., HF, T₂, and TF). In one example, the sorbent coating includes a metal-organic framework known to adsorb hydrogen gas isotopes, such as ZIF-4, ZIF-8, and UiO-66. Moreover, the sorbent coating may be formed into a paint, paste, or malleable clay-like material such that it may be disposed and spread about a surface of the stainless-steel vessels and enclosures of the MSR system thereby preventing any anticipating diffusion therethrough. In this regard, the one or more metal-organic frameworks of the coating will capture gaseous fission products (e.g., HF, T₂, and TF). Advantageously, by coating MSR components with the MOF-containing coating (hereafter “MOF coating”), tritium that may otherwise diffuse through the stainless steel will be captured instead, improving the containment capabilities of the MSR system. Additionally, and as discussed in greater detail herein, the MOF coating may be incorporated into other systems of the MSR where tritium is anticipated to be present. As a nonlimiting example, the coating may be incorporated into a cartridge suspended in a headspace of a salt-bearing vessel. As another nonlimiting example, the coating may be incorporated into the off-gas system of the MSR.

To facilitate the foregoing, the MOF coating includes one or more sorbent metal-organic frameworks or “MOFs.” Generally, MOFs comprise metal clusters bound together by organic linkers or ligands. MOFs are an extensive class of crystalline materials with high porosity and internal surface area. These properties, combined with their high degree of variability for both organic (i.e., organic linkers) and inorganic (i.e., metal clusters) components provide MOFs with a wide variety of use cases. Particularly, the polarity and pore size of MOFs may be customized via reaction conditions to meet a variety of needs. In this regard, MOFs may be employed as a storage medium for gases, such as hydrogen (and tritium), and as a high-capacity sorbent to meet various separation needs. As will be discussed in greater detail herein, MOFs are known to capture (e.g., via adsorption) gaseous fission product, for example HF, T₂, and TF.

In several embodiments and as described in greater detail herein, the MOF coating may be applied to a surface of one or more reactor enclosures and capture fission products thereat. In several embodiments, the MOF coating is applied to the reactor enclosure (e.g., a stainless-steel surface) by growing the associated MOF on the associated surface. In this regard, the MOF reagents and surface for adherence may be immersed in solution to allow the MOF to grow on said surface. In some embodiments, the MOF coating is initially prepared then applied to the surface for adherence as described herein. In several embodiments as described herein, the ligands of the MOF may be activated and the surface or substrate desired to be coated is oxidized, thereby causing the MOFs to anchor to the surface or substrate. In several embodiments, the MOFs are immobilized onto the surface or substrate and anchored thereto via ligand anchoring (e.g., via interactions between deprotonated ligands of the MOFs and the oxidized surface). In this regard, a MOF coating may be applied to various components of an MSR system.

In other embodiments, the MOF may be formed into a composite that includes a substrate, to which the one or more MOFs are adhered to and/or immobilized (i.e., bound in a stationary manner) into. Such a substrate may serve as the solid medium upon which the one or more MOFs are connected to. In some examples, the MOFs may be immobilized onto a surface of the substrate in a core and shell configuration forming two distinct layers. In some examples, the MOFs may be integrated into the substrate forming a single layer. Suitable substrates include those capable of binding to the one or more MOFs, resisting the corrosive properties of the molten fuel salt, and resisting the temperature of an MSR system (e.g., at least 500° C.). In several embodiments and as described herein, the MOF is incorporated into a clay or paste composite. In these embodiments, the clay or paste material is added to solution with the metal salts and organic ligands that form the MOF at an initial mixing step, thus causing all components to form together as a MOF composite.

The MOF coating and composites of the present disclosure may include one or more MOFs. In this regard, the coating and/or composite may include a collection of the same MOF, a collection of MOFs to the same or similar family, or a collection of MOFs of different or dissimilar families. In at least one embodiment, the MOF coatings and composites of the present disclosure include MOFs configured to capture gaseous fission products, such as tritium species. Generally, the MOFs capture the gaseous fission products via specific interactions between the gas molecules and the framework surface. For example, hydrogen gas may be adsorbed by a MOF via physisorption, which is governed by weak van der Waals forces. As another example, gas adsorption is facilitated via chemisorption, which involves cooperative binding mechanisms between the MOF and the gas molecules. In many examples, the MOF described herein facilitate adsorption via a combination of physisorption and chemisorption.

In this regard, the MOFs included in the MOF coatings and composites of the present disclosure may include any number of the Zeolitic Imidazolate Framework or “ZIF” family (e.g., ZIF-4, ZIF-8, Cu-ZIF-8, ZIF-9, ZIF-11, and ZIF-12), of the Universitet i Oslo or “UiO” family (e.g., UiO-66 and UiO-66-NH2), of the coordination framework from Augsburg or “CFA” family (e.g., CFA-2, CFA-10, and CFA-12), of the Hong Kong University of Science and Technology or “HKUST” family (e.g., HKUST-1), of the Matériaux de l'Institut Lavoisier or “MIL” family (e.g., MIL-57, and MIL-123), of the Molecular Sieve Versailles Santa Barbara or “VSB” Family (e.g., VSB-5), of the Stonybrook Metal-Organic Framework or “SBMOF” family (e.g., SBMOF-1, and SBMOF-2), or of the Ultralightweight Metal-Organic Framework or “ULMOF” family (e.g., ULMOF-1, ULMOF-2, and ULMOF-3). In at least one embodiment, the MOF coating and/or composite comprises ZIF-4, ZIF-8, and/or UiO-66).

The MOF coatings of the present disclosure may include MOFs selected for their temperature resistant capabilities. For example, the MOF coating may include MOFs constructed from high-valence or “hard” metal ions, such as Zr⁴⁺, Al³⁺, Ti⁴⁺, and Cr³⁺ and/or “hard” carboxylate-based ligands.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

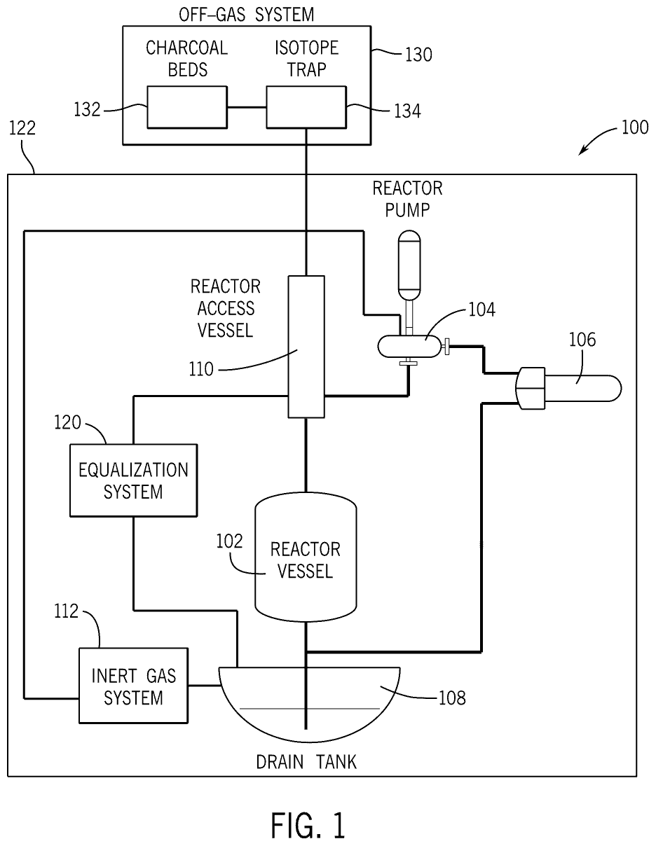

FIG. 1 illustrates an example molten salt reactor (MSR) system 100 to which the MOF coating of the present disclosure may be employed, as depicted schematically in FIG. 1. As will be discussed in greater detail herein, the MOF coating may be employed in reactor enclosure 122, the reactor vessel 102, the reactor access vessel 110, and/or the off-gas system 130. In various embodiments, MSR system 100 utilizes fuel salt enriched with uranium (e.g., high-assay low-enriched uranium) to create thermal power via nuclear fission reactions. In at least one embodiment, the composition of the fuel salt is LiF—BeF₂—UF₄, though other compositions of fuel salts may be utilized as fuel salts within the reactor system 100 (e.g., other fluoride salts, chloride salts, or a mixture thereof). The fuel salt within the system 100 is heated to high temperatures (about 600-700° C.) and melts as the system 100 is heated. In several embodiments, the MSR system 100 is at least partially enclosed by a reactor enclosure 122. In this regard, several or all salt-bearing vessels and components (i.e., those having the fuel salt flowing therethrough) may be housed within the reactor enclosure 122. The reactor enclosure 122 may generally serve to contain the components of MSR system 100. The reactor enclosure 122 may generally comprise one or more distinct layers, for example a thermal insulation layer and an outer radiation shielding layer. In one example, the reactor enclosure 122 includes a thermal insulation layer defining a thermal region therein operable to maintain a high temperature necessary to maintain a molten phase of the fuel salt (i.e., 500-700° C.). In this regard, all or substantially all salt-bearing components (e.g., those containing fuel salt, or making contact with fuel salt) are disposed within the thermal region. The insulating layer effectively functions as an oven by insulating the heat produced via fission reaction (or by external heaters) within the reactor vessel 102 to maintain an operational temperature of the MSR system 100. In several embodiments, the molten salt reactor system 100 includes a reactor vessel 102 where the nuclear reactions occur within the molten fuel salt, a fuel salt pump 104 that pumps the molten fuel salt to a primary heat exchanger 106, such that the molten fuel salt re-enters the reactor vessel after flowing through the heat exchanger, and piping in between each component. The piping between each component facilitates circulation of the molten salt and may be collectively referred to as the molten salt loop. However, MSR system 100 may be a “pool-type” reactor, that is, where all or substantially all salt-bearing components are disposed within a pool of molten fuel salt. In this regard, U.S. application Ser. No. 18/449,445, filed Aug. 14, 2023, and entitled “MOLTEN SALT REACTOR CONTAINMENT” is incorporated by reference in its entirety as if fully set forth herein. MSR system 100 may also include additional components, such as, but not limited to, drain tank 108 and reactor access vessel 110. The drain tank 108 may be configured to store the fuel salt once the fuel salt is in the reactor system 100 but in a subcritical state and also acts as storage for the fuel salt if power is lost in the system 100. The reactor access vessel 110 may be configured to allow for introduction of small pellets of uranium fluoride (UF₄) to the system 100 as necessary to bring the reactor to a critical state and compensate for depletion of fissile material.

MSR system 100 may include an inert gas system 112 to provide inert gas (e.g., nitrogen) to a head space of the drain tank 108, among other functions. The inert gas system 112 may further relieve inert gas from the headspace of the drain tank 108 as needed. The inert gas system 112 is therefore operable to maintain pressurized inert gas in the headspace of the drain tank 108 that is sufficient to substantially prevent the flow of molten fuel salt into the drain tank during normal operations. In some embodiments, the inert gas system 112 is operable to maintain a pressure below atmospheric pressure within the headspace. For example, with the headspace of the drain tank 108 pressurized by the inert gas system 112, molten fuel salt may generally circulate between the reactor vessel 102 and the primary heat exchanger 106 without substantially draining into the drain tank 108. In some cases, the inert gas system 112 may be configured to supply inert gas to the headspace of various other components of the molten salt reactor system 100, such as to the headspace of the reactor access vessel 110, to the seal of reactor pump 104, among other components. Upon the occurrence of a shutdown event, the inert gas system 112 may cease providing inert gas to the head space of the drain tank 108 and other components to which the system 112 supplies inert gas. Consequently, this causes the pressure in the headspace of the drain tank 108 to decrease. Upon pressure decrease the fuel salt gravitationally drains to the drain tank 108, which may be located at a lowermost section of the MSR system 100. Advantageously, in the event of a loss of power, emergency situation, or other failure event, the inert gas system 112 may allow the fuel salt to drain passively into the drain tank 108 rather than circulating to the reactor vessel 102, thereby potentially avoiding pressure build up during such loss of power or other failure event.

The molten salt reactor system 100 may further include an equalization system 120 to work in conjunction with the inert gas system 112. The equalization system 120 is operable to equalize the pressure between the headspace of the drain tank 108 and the reactor vessel 102 upon the occurrence of a shutdown event. In this regard, the equalization system 120 may be operable to fluidically couple (via opening one or more valves) the head space of the drain tank 108 and the reactor vessel 102 to reduce or eliminate the pressure differential, thereby allowing the fuel salt to readily flow into the drain tank upon the shutdown event as described with reference to the inert gas system 112.

In several embodiments, MSR system 100 further includes an off-gas system 130 operable to process off-gas produced by the MSR system 100. As a consequence of nuclear fission and general operation, the MSR system 100 may utilize and produces a wide variety of gases or “off-gas” which needs to be processed due to their contact and mixing with radioactive substances. The off-gas may include gaseous fission products (e.g., HF, T₂, and TF). The off-gas system 130 may include a number of interrelated systems operable to handle and/or process large quantities of off-gas ranging from non-radioactive, potentially radioactive, and always radioactive. For example, the off-gas system may include one or more charcoal beds 132 generally operable to filter and/or trap off-gas and to allow radioactive gases (e.g., krypton and xenon) to decay prior to discharge.

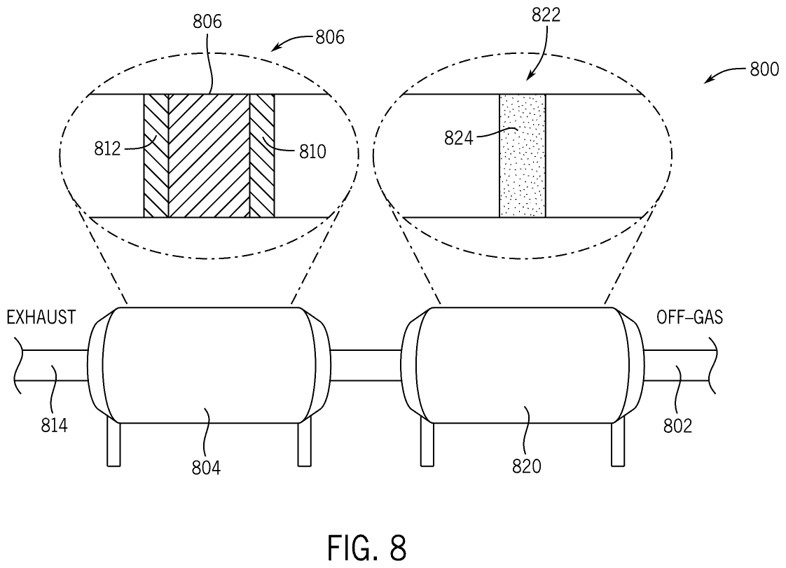

Additionally and as discussed in greater detail with reference to FIG. 8, the off-gas system 130 may include one or more isotope traps 134 operable to capture gaseous fission products, such as HF, T₂, and TF, that may be corrosive to charcoal beds 132. The one or more isotope traps 134 may include or otherwise incorporate the example MOF coatings described herein. In one example, the isotope trap 134 is positioned upstream of the one or more charcoal beds 132 to prevent corrosive HF and TF from damaging the one or more charcoal beds 132. Additionally or alternatively, the example MOF coatings described herein may be disposed about or otherwise coat surfaces of the reactor enclosure 122. Advantageously, by coating the reactor enclosure 122 with the MOF coating, tritium that may otherwise diffuse through the stainless steel of the enclosure 122 may be captured and prevented from escaping from MSR system 100. Additionally or alternatively, the example MOF coatings described herein may be integrated in a cartridge suspended within a headspace of a vessel of MSR system 100, for example the reactor access vessel 110.

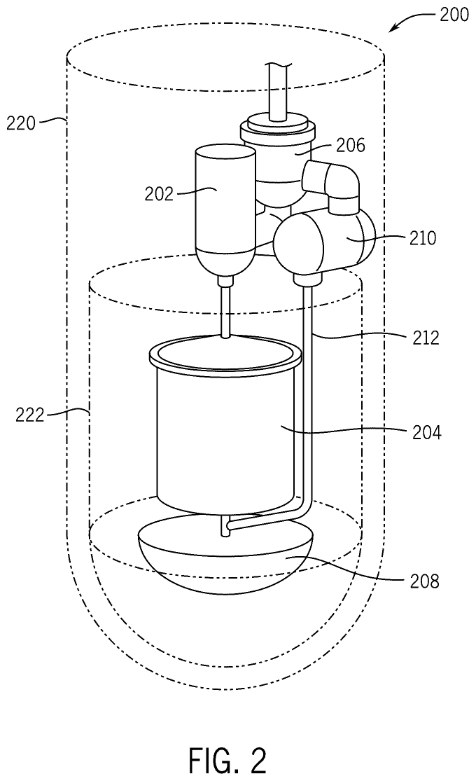

In several embodiments, the MOF coating is a thin film spread over the surface and/or substrate at a concentration sufficient to capture tritium generated by MSR operation or at least to a sufficient degree to improve the containment capabilities of the associated surface and/or substrate (e.g., reactor enclosure, internal shielding vessel, etc.). In this regard, it is anticipated that the molten fuel salt of system 100 will produce about 1.5 Ci of tritium per day. In many cases, it is desirable for operators to anticipate and address tritium produced through the entire lifecycle of the reactor system. As a practical example, system 100 may be a 1 MWth reactor system designed for continuous operations for 5 years. In this example, system 100 is anticipated to generate about 6×10²² atoms of tritium or about 0.1 moles of tritium over its 5-year lifecycle. In this regard, the MOF coating of the present disclosure may have an uptake capacity sufficient to capture 0.1 moles of tritium. Such a sufficient uptake capacity may be achieved by including sufficient concentration of MOFs within the MOF coating. For example, the MOF coating may include a MOF concentration from 3.0 to 8.0 mmol/g. However, in other examples, the MOF concentration is less than 3 mmol/g or greater than 8.0 mmol/g. As another example, the MOF coating may have a thickness of about 3 mm (e.g., as evenly applied over a 3 m diameter reactor vessel). However, in other examples, the MOF coating has a thickness less than or greater than 3 mm. In several embodiments, the 3 mm thickness of MOF coating is distributed over one or more surfaces of reactor enclosure 122. In other embodiments, the 3 mm of MOF coating is distributed over one or more of the internal shielding layer and reactor enclosure of MSR system 100 (e.g., with reference to FIG. 2). Additionally, those skilled in the art will appreciate that a higher MOF concentrated MOF coating and/or a thicker MOF coating may be used for reactor systems based on their power output and anticipated lifespan, that is as associated with the anticipated tritium output as described herein.

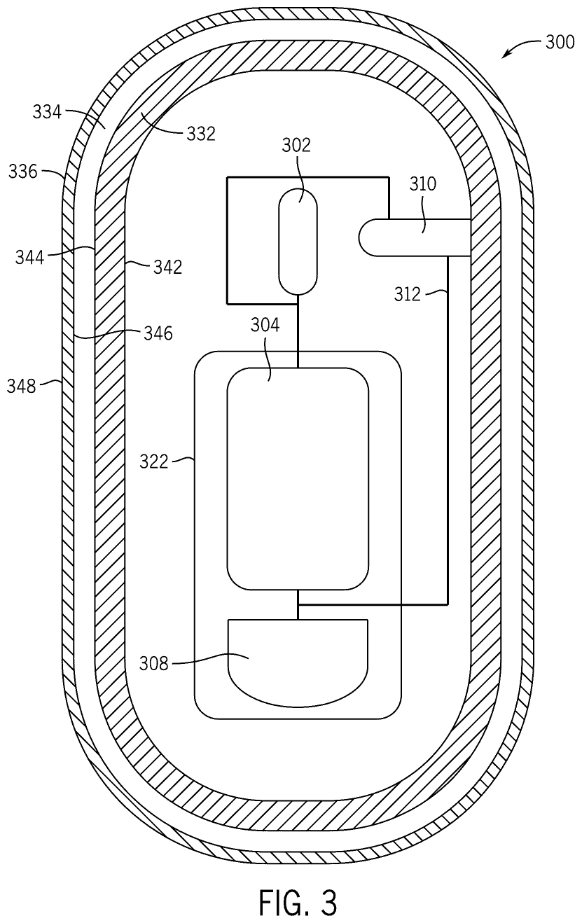

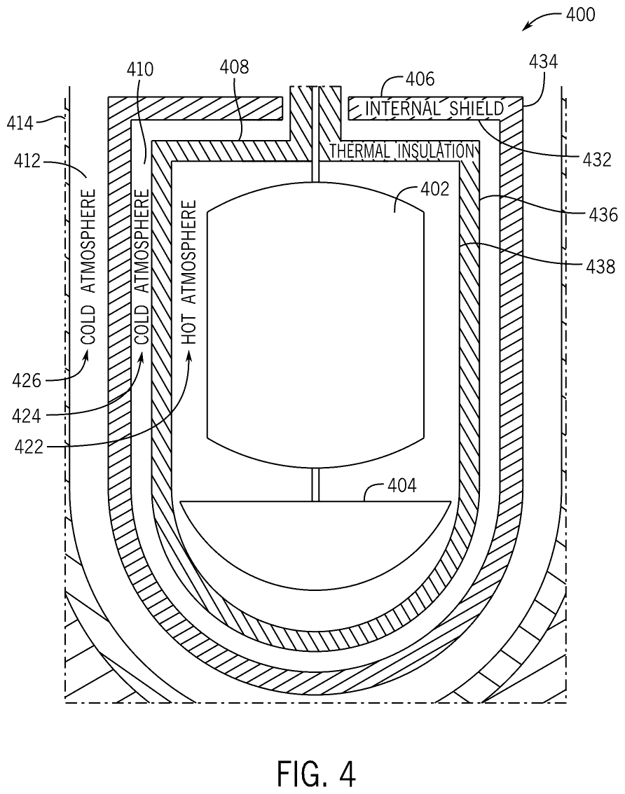

FIG. 2 illustrates an isometric and semi-transparent view of an example MSR system 200. The example MSR system 200 may be substantially analogous to that of FIG. 1 and include a reactor access vessel 202, reactor vessel 204, a pump 206, a heat exchanger 210, a drain tank 208, and piping 212 therebetween redundant description of which is excluded for clarity. FIG. 2 depicts one or more enclosures or vessels to which the MOF coating may be employed. The enclosures and vessels may be generally operable to contain the radiation and heat generated by MSR system 200 and maintain an elevated internal temperature to keep the fuel salt in a molten phase, shield an environment of the MSR system 200 from radiation, shield an environment of the MSR system 200 from the heat produced, and contain any gas or liquid leaks. In this regard, MSR system 200 may include a reactor enclosure 220 encompassing all or substantially all salt-bearing components of the MSR system 200 (e.g., reactor access vessel 202, reactor vessel 204, a pump 206, a heat exchanger 210, a drain tank 208, and piping 212 therebetween). As will be discussed in greater detail with reference to FIG. 3, a MOF coating may be disposed about and/or immobilized on surfaces of reactor enclosure 220 to capture gaseous fission products. In one embodiment, the MOF coating is spread over an exterior surface of reactor enclosure 220, thereby being positioned outside the oven where the temperature is anticipated to be cooler (e.g., less than 600° C.). Additionally or alternatively, MSR system 200 may include an internal shielding enclosure or vessel 222 encompassing the reactor vessel 204 and drain tank 308 and fully disposed within the reactor enclosure 220. As will be discussed in greater detail with reference to FIG. 4, a MOF coating may be disposed on a surface of internal shielding vessel 222 to capture gaseous fission products. Each enclosure 220, 222 may comprise a collection of distinct layers collectively operable to facilitate the functions thereto and serving as surface upon which the MOF coating may be disposed. Enclosure 220 and vessel 222 may generally comprise stainless steel.

FIG. 3 illustrates a cross-sectional view of an example reactor enclosure 300. Reactor enclosure 300 may encompass salt-bearing components of an MSR system, for example, a reactor access vessel 302, a reactor vessel 304, a heat exchanger 310, a drain tank 308, and piping 312 therebetween all of which may be substantially analogous to those described with reference to FIGS. 1 and 2. Reactor enclosure 300 may encompass other components related to the operation of an MSR but are excluded from FIG. 3 for clarity. Additionally or alternatively reactor enclosure 300 may encompass internal shielding vessel 322, which further encompasses reactor vessel 304 and drain tank 308. In one embodiment and as depicted in FIG. 3, reactor enclosure 300 includes one or more distinct layers collectively operable to thermally insulate the salt-bearing components, contain any gas or liquid leaks, shield an environment external to the reactor enclosure 300 from radiation (i.e., provide radiation shielding capabilities), and otherwise contain the molten fuel salt and gaseous fission products. In this regard, reactor enclosure 300 may include a thermal insulation layer 332, a gap 334, and an outer radiation shielding layer 336. While FIG. 3 may illustrate these layers of being a certain width and size, one of ordinary skill in the art will appreciate that these layers (and all components depicted in FIG. 3) may not be drawn to scale and may be of varying size and thickness based on the specific design.

Reactor enclosure 300 may be a vessel housing the components of an MSR system (e.g., MSR system 100, 200). In this regard, reactor enclosure 300 may be a cylindrical stainless-steel vessel. Radiation shielding layer 336 may be generally operable to shield an environment exterior to the reactor enclosure 300 from radiation or otherwise contain radiation generated from nuclear fission occurring within the MSR system. The radiation shielding layer 336 may be composed of a radiation shielding or absorbing material known in the art, for example lead, tungsten, stainless steel, concrete, heavy metal compositions, or any combination thereof. Radiation shielding layer 336 may encompass a thermal insulation layer 332 with a gap 334 interposed there between. The thermal insulation layer 332 may be generally operable to thermally insulate the salt-bearing components.

As previously discussed, it is anticipated that gaseous fission products (e.g., T₂ and TF) will be produced within the MSR system as a consequence of operation. Tritium is known to diffuse, penetrate, or otherwise pass through stainless steel, the material typically used as the reactor enclosure. Tritium should be contained within the reactor enclosure 300 despite its penetrating ability due to its hazardous nature. In several embodiments as described herein, the MOF coating may be disposed about or spread over surface of the reactor enclosure 300 (and any vessels contained therein) to prevent tritium from escaping out of the system 300. Advantageously, by incorporating the MOF coating of the present disclosure with the reactor enclosure 300, the containment abilities of the reactor enclosure 300 may be improved at least due to the ability of MOF coating to capture tritium that may otherwise diffuse or penetrate through the enclosure 300.

In several embodiments, the MOF coating may be disposed and/or spread about one or more surfaces of the reactor enclosure 300. In this regard, the MOF coating may partially, substantially, or completely coat the reactor enclosure 300 and/or any vessels contained therein. As illustrated in FIG. 3, reactor enclosure 300 may include several surfaces that the MOF coating may be disposed on to. As will be understood by those having skill in the art in view of the present disclosure, the one or more MOFs of the MOF coating may be sensitive to extreme temperature present about the MSR system. Furthermore, the temperature generally decreases based on the distance from the reactor core (i.e., within reactor vessel 304) and may substantially decrease at vessel and enclosure thresholds (e.g., due to insulation). In this regard, it is advantageous to position the MOF coating about external surfaces of enclosures and vessels to avoid damage to the MOFs used and to expand the selection of MOFs that may be included in the MOF coating. However, the MOF coating of the present disclosure may be disposed and/or spread about several different surfaces of the MSR system. Additionally or alternatively, the MOFs included in the MOF coating may be selected from those having high temperature resistive properties. In this regard, selection of the high-temperature-resistant MOF may be facilitated based on the particular metallic center, ligands, and substrate base of the MOF coating. In several embodiments, the MOF of the MOF coating is constructed from high-valence or “hard” metal ions (e.g., Zr⁴⁺, Al³⁺, Ti⁴⁺, and Cr³⁺) paired with “hard” carboxylate-based ligands. For example, ZIF-4, ZIF-8, and/or UiO-66 may be selected due, at least in part, to their temperature resistant capabilities.

As illustrated in FIG. 3, thermal insulation layer 332 may define an internal surface 342 facing the salt-bearing components and an external surface 344 facing the gap 334. Additionally, radiation shielding layer 336 may define an internal surface 346 facing the gap 334 and an external surface 348 facing an external environment. In several embodiments, the MOF coating is disposed on one or more of surface 342, 344, 346, and/or 348. In at least one embodiment, the MOF coating is adhered directly onto surfaces 342, 344, 346, and/or 348. In other embodiments, the MOF coating is initially adhered on an intermediary metallic surface or substrate, which is then placed or otherwise attached to surfaces 342, 344, 346, and/or 348. Advantageously, the MOF coating prevents gaseous tritium species from escaping reactor enclosure 300 via adsorbing, absorbing, neutralizing, or otherwise containing the gaseous tritium species upon contact. In this regard and depending upon the particular surface coated, tritium may be captured prior to diffusion or following diffusion through thermal insulation layer 322 and/or radiation shielding layer 336.

In certain embodiments, the MOF coating of the present disclosure may be disposed over surfaces other than or in addition to those defined by the reactor enclosure 300. In this regard and with reference to FIG. 4, an example internal shielding vessel 400 is shown, which defines surfaces to which the MOF coating may be disposed onto. For context, internal shielding vessel 400 may be a system of an MSR (e.g., MSR 100, 200) operable to control a temperature proximal to a reactor vessel (containing the reactor core) such that operational temperatures may be maintained. In this regard, internal shielding vessel 400 may be substantially analogous to that described in U.S. patent application Ser. No. 18/450,884 filed on Aug. 16, 2023, which is hereby incorporated by reference in its entirety. Internal shielding vessel 400 may be analogous to that of FIGS. 2 and 3 in that it encompasses a reactor vessel 402 and drain tank 404. In several embodiments, internal shielding vessel 400 includes a plurality of distinct layers collectively operable to maintain and/or control the operational temperature of the MSR system. For example, internal shielding vessel 400 includes an internal shielding layer 406 and an inner thermal insulation layer 408, both of which may comprise, among other materials, stainless steel. Internal shielding layer 406 and inner thermal insulation layer 408 collectively define a first gap 410 interposed therebetween. Additionally, a second gap 412 may be defined between internal shielding layer 406 and a reactor enclosure layer 414. As discussed in the '885 application, a hot atmosphere 422 may be defined by inner thermal insulation layer 408; a cold atmosphere 424 may be defined within gap 410; and a cold atmosphere 426 may be defined within gap 412. Hot atmosphere 422 denotes an area of high enough temperature to sufficiently maintain a molten state of the fuel salt (e.g., 500-700° C.); cold atmosphere 424 and 426 denotes an area with temperatures generally lower than that of hot atmosphere 422. In one example, cold atmosphere 426 has a temperature lower than that of cold atmosphere 424. Each of the aforementioned layers are collectively operable to maintain and/or control a temperature of gap 412 to at or below a temperature that is suitable for the operation and/or integrity of certain components of the system, such as by maintaining a temperature of 412 at or below a temperature that would otherwise cause mechanical weakness of the concrete or structural steel included therein (i.e., that of reactor enclosure 414).

Each of the aforementioned layers define surface onto which the MOF coating may be disposed onto in order to capture gaseous fission products (e.g., tritium). For example, internal shielding layer 406 includes an inner surface 432 facing gap 410 and an outer surface 434 facing gap 412. As another example, internal thermal insulation layer 408 includes an inner surface 438 facing the reactor vessel 402 and an outer surface 436 facing gap 410. In several embodiments, the MOF coating may be disposed on one or more of surface 432, 434, 436, and/or 438. In at least one example, the MOF coating is adhered directly to one or more of surfaces 432, 434, 436, and/or 438. In another example, MOF coating is initially adhered to a metallic material or surface, which is then adhered to one or more of surfaces 432, 434, 436, and/or 438. In several embodiments, the MOF coating is disposed onto surfaces facing cold atmosphere 424, 426 (e.g., surface 436, 434) as cold atmospheres 424, 426 have a lower temperature, thereby enabling use of a wider range of MOFs that may otherwise decompose in the hot atmosphere 422 due to the high temperature. However, one skilled in the art will appreciate that the MOF coating may be placed on any combination of surfaces based on the need. Furthermore, the MOF coating may be disposed on any combination of surfaces of the internal shielding vessel 400 and any combination of surfaces of the reactor enclosure 300.

In several embodiments, the MOF coating includes one or more MOFs disposed on one or more surfaces of one or more enclosures or vessels of the MSR system. In other embodiments, the MOFs are first adhered to a metallic substrate (i.e., an intermediary material), which is then adhered to the aforementioned one or more surfaces. As will be discussed in greater detail herein, the MOF and the surface upon which it will be adhered to may undergo pretreatment to ensure the MOFs are securely anchored.

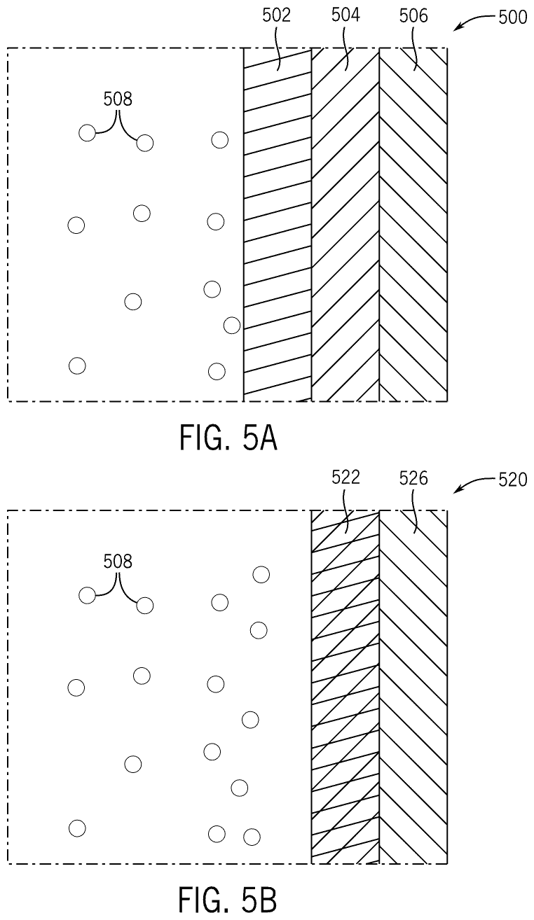

FIG. 5A illustrates an example metal-organic framework coating 500. The embodiment depicted in FIG. 5A illustrates a MOF coating 500 comprising the one or more MOFs 502, an intermediary material serving as the substrate 504, and the surface 506 of the MSR enclosure or vessel. FIG. 5A illustrates a configuration where the one or more MOFs 502 are immobilized onto and intermediary material 504 serving as a substrate, which is then attached to the surface 506 of the desired enclosure or vessel (e.g., surface 342, 344, 346, and/or 348 of FIG. 3 and/or surface 432, 434, 436, and/or 438 of FIG. 4). Surface 506 may be any of the aforementioned enclosures or vessels described in reference to FIGS. 3 and 4 (e.g., reactor enclosure 300 and internal shielding vessel 400). As illustrated in FIG. 5A, gaseous fission products 508 (e.g., T₂, TF, HF, etc.) may be present within the MSR system. In several embodiments, MOF coating 500 is configured to capture (e.g., via adsorption, absorption, neutralization, etc.) the gaseous fission products 508 thereby preventing their escape from the MSR system (e.g., via diffusion through surface 506).

In at least one embodiment, the intermediary material substrate 504 is a removable substrate (e.g., one removably coupled or otherwise not permanently affixed to surface 506). The embodiment depicted in FIG. 5A enables operators to remove the MOF coating 500 (or at least more easily remove MOF coating 500), for example, once the MOF coating 500 is saturated with gaseous fission products 508. In this regard, the embodiment depicted in FIG. 5A may be advantageously employed to facilitate MOF coating 500 removal upon maintenance of the MSR system (or upon some other scheduled time) without affecting the surface 506 of the MSR enclosure or vessel. In one embodiment, a radiation counter may be included proximal to MOF coating 500 and configured to detect beta emission from the MOF coating 500, advantageously indicating the amount of tritium currently captured by the MOF coating 500. In this regard, the radiation counter may be employed to measure the level of saturation associated with the MOF coating 500. In one example, beta emissions associated with MOF coating 500 are monitored to determine whether MOF coating 500 is saturated to a sufficient degree to warrant removal and, for example, replacement.

FIG. 5B illustrates another example metal-organic framework coating 520. The embodiment depicted in FIG. 5B illustrates a MOF coating 520 comprising the one or more MOFs 522 adhered directly onto the surface 526. FIG. 5B illustrates a configuration where the one or more MOFs 526 are immobilized directly onto the surface 526 of the desired enclosure or vessel (e.g., e.g., surface 342, 344, 346, and/or 348 of FIG. 3 and/or surface 432, 434, 436, and/or 438 of FIG. 4). Surface 526 may be any of the aforementioned enclosures or vessels described in reference to FIGS. 3 and 4 (e.g., reactor enclosure 300 and internal shielding vessel 400). As illustrated in FIG. 5B, gaseous fission products 508 (e.g., T₂, TF, HF, etc.) may be present within the MSR system. In several embodiments, MOF coating 500 is configured to capture (e.g., via adsorption, absorption, neutralization, etc.) the gaseous fission products 508 thereby preventing their escape from the MSR system (e.g., via diffusion through surface 506).

While FIGS. 5A and 5B illustrates embodiments where the MOF coating 500, 520 is disposed on an internal surface, one having ordinary skill in the art will appreciate that MOF coating 500, 520 may be disposed on external surfaces of reactor enclosures and vessels.

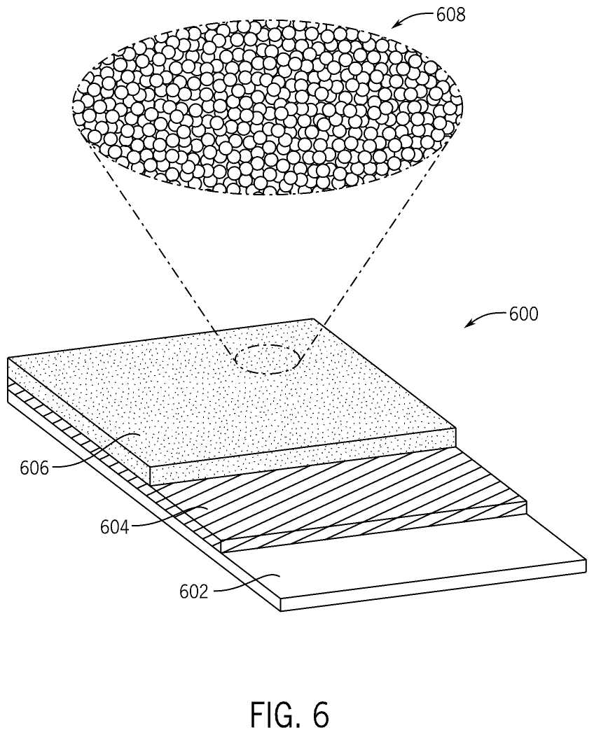

FIG. 6 illustrates a detailed view of an example configuration 600 of MOF coating 606 on a reactor enclosure 604. In the embodiment depicted in FIG. 6, the MOF coating 606 is disposed on an exterior surface of enclosure 604, which encompasses reactor space 602. Reactor space 602 may be an internal volume of reactor enclosure 604 containing gaseous fission products. In this regard, MOF coating 606 may be immobilized (i.e., via ligand anchoring) onto reactor enclosure 604. In several embodiments, reactor enclosure 604 is substantially analogous to reactor enclosure 300.

FIG. 6 provides a detailed view of the MOF coating 606 such that collection of one or more MOFs 608 is in view. The one or more MOFs 608 may be, in one example, a collection of a single type or composition of MOF or may be, in another example, a collection of different types or compositions of MOFs. Both embodiments are anticipated by the present disclosure. As understood by those having skill in the art, MOFs may be configured to gas capture and/or filtration with certain MOFs and MOF families being particularly selective for certain species. Advantageously, the MOF coating of the present disclosure may include one or more MOFs (including a collection of MOFs of a similar or dissimilar family) to capture the gaseous fission products. In at least one embodiment, MOFs 608 include one or more Zeolitic Imidazolate Frameworks (“ZIF”) operable to capture tritium and other hydrogen species (e.g., ZIF-4, ZIF-8.) In at least one embodiment, MOFs 608 including Universitet i Oslo or “UiO” family (e.g., UiO-66and UiO-66-NH2).

Advantageously, configuration 600 includes the MOF coating 606 positioned on an exterior surface, thereby positioning the MOFs 608 in a cooler environment relative to an interior surface while still capturing gaseous fission products potentially diffusing through enclosure 604.

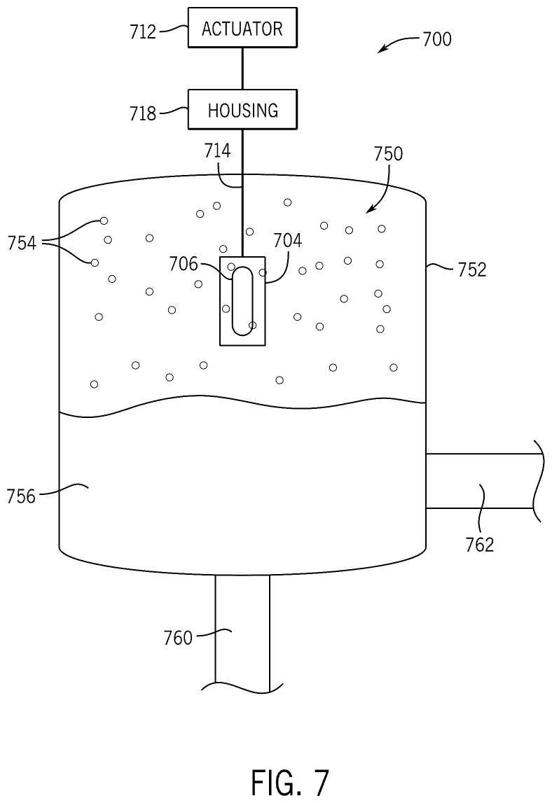

In one embodiment, the MOF coating of the present disclosure is integrated into a cartridge suspended into a headspace of a salt-bearing vessel to capture gaseous fission products suspended therein. In this regard, the MOF coating may be adhered to a wire mesh or similar structure contained within a porous cartridge. In several embodiments, the cartridge is included in or otherwise associated with a suspension assembly generally operable to suspend the cartridge (and consequently the MOF coating) in a headspace and remove the cartridge from said headspace following gaseous fission product capture. In this regard and with reference to FIG. 7, an example suspension assembly 700 is shown.

The example suspension assembly 700 includes a cartridge 704 suspended in a headspace 750 of a vessel 752 where the headspace 750 includes gaseous fission products 754 (e.g., gaseous tritium species such as T₂, TF and other gaseous fission products such as HF). Vessel 752 may be any salt-bearing component of an MSR system, for example, reactor access vessel 110, 202, 302. Vessel 752 includes molten fuel salt 756 where the gaseous fission products 754 may originate from and which may enter and exit vessel 752 via inlet pipe 760 and outlet pipe 762, respectively. Cartridge 704 may house a wire mesh 706 or other substrate including the MOF coating described herein. In this regard, cartridge 704 may be a porous container or filter configured to facilitate contact of the gaseous fission products 754 with the MOF coating.

In one embodiment, cartridge 704 is suspended in headspace 750 via a suspension assembly 710 operable to suspend cartridge 704 into headspace 750 and operable to remove cartridge 704 from headspace 750. To facilitate the forging, suspension assembly 710 may include a housing 718 and an actuator 712. The housing 718 is configured to receive the cartridge 704 following fission gas capture. The actuator 712 is operable to lower the cartridge 704 down into the headspace 750. The actuator 712 may be further operable to remove the cartridge 704 from the headspace 750 by raising cartridge 704 up into housing 718. In this regard, housing 718 may be configured to store cartridge 704 including the MOF coated substrate 706 for removal from the vessel 752. In one example, actuator 712 includes a reel assembly extending through housing 718 and coupled with attachment rod 714, such that cartridge 704 may be lowered or raised into and out of the headspace 750. In one example, housing 718 includes a latch or valve operable to isolate housing 718 from headspace 750, for example, following retraction of cartridge 704 into housing 718. Additionally, housing 718 may include a salt barrier configured to prevent molten fuel salt 756 from entering housing 718 while the cartridge 704 is in the suspended position. In this regard, salt barrier may be horizontally positioned within housing 718 and configured to completely or substantially cover the latch or valve while in an open position, thereby preventing and molten fuel salt 756 from entering housing 718 during fission product capture.

In one embodiment, the MOF coating of the present disclosure is integrated into an off-gas system of an MSR system. In this regard, the MOF coating may be employed to capture tritium contained within the off-gas. In at least one embodiment, the MOF coating is positioned upstream of other gas filters (e.g., activated charcoal filters) to avoid damage thereto. In this regard, and with reference to FIG. 8, an example off-gas system 800 is shown.

Off-gas system 800 may be coupled to an MSR system (e.g., those shown in FIGS. 1 and 2) and receive an off-gas therefrom. The off-gas may include non-radioactive, potentially radioactive, and radioactive gaseous fission products (e.g., TF and HF) produced as a consequence of operation of the MSR system. In one embodiment, off-gas system 800 includes one or more gas tanks including filtration systems operable to capture, contain, or otherwise process off-gas from the MSR system. For example, off-gas system 800 may receive off-gas from an MSR system by piping inlet 802. As a nonlimiting example, piping inlet 802 may be coupled to reactor access vessel 206 of FIG. 2 via piping that penetrates reactor enclosure 220. Off-gas system 800 may include at least one charcoal filled gas tank 804 including a charcoal bed 806. Charcoal beds 806 may include activated charcoal generally operable to capture and allow radioactive compounds, such as radioactive iodine, to decay therein. Additionally, charcoal beds 806 may be operable to capture noble gases of the off-gas advantageously removing nuclear poisons from the off-gas. In this regard, charcoal bed 806 may generally comprise activated charcoal 808, filter inlet 810, and filter outlet 812. Following processing, the off-gas may exit through exhaust 814.

Certain gaseous fission products are known to corrode charcoal beds. For example, HF and TF may damage, corrode, or otherwise hinder the ability of charcoal bed 806 to process the off-gas. In this regard, charcoal bed 806 may become fluorinated upon contact with HF, rending them useless for their intended purpose. Additionally, graphite is known to develop carbon-fluoride bonds when exposed to fluorinated molten salt and HF, consequently reducing ability for the graphite core to interact with other substances and function. To prevent such consequences and in one embodiment, off-gas system 800 may further include a gas tank 820. The gas tank 820 may include isotope trap 822 and may be positioned upstream of at least one charcoal filled gas tank 804. In this regard, isotope trap 822 may be a filter including the MOF coating of the present disclosure. In one embodiment, the MOF coating is applied to a substrate 824 (e.g., wire mesh, filter, etc.). In one embodiment, the MOF coating is adhered to substrate 824 via immobilization onto the substrate via ligand anchoring. In this regard, substrate 824 may contact off-gas received from piping inlet 802 and capture or otherwise remove gaseous fission products (e.g., HF, TF, T₂) from the off-gas stream, advantageously intercepting corrosive gases from entering gas tank 804 and damaging charcoal bed 806.

As will be understood by those skilled in the art, FIG. 8 illustrates a simplified view of an off-gas system. In this regard, the off-gas system 800 of FIG. 8 may include a plurality of gas tanks including charcoal beds and other filters and equipment typically utilized for handling and processing an off-gas from a nuclear reactor system. Additionally, off-gas system 800 may include one or more isotope traps 822, each including MOF coatings having MOFs of the same or different composition based on the need.

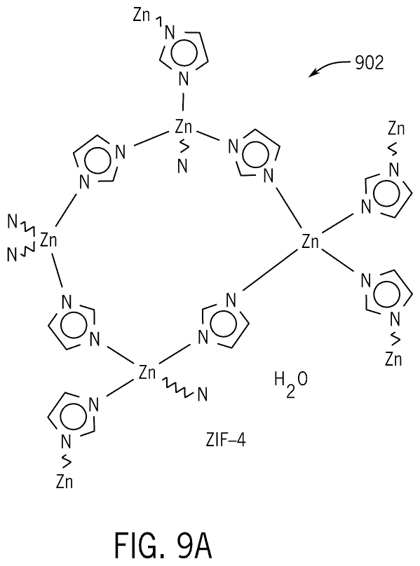

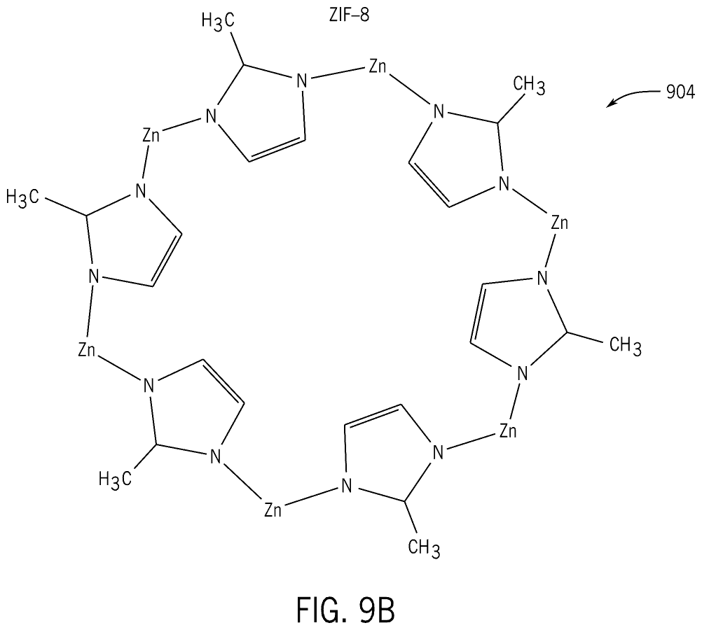

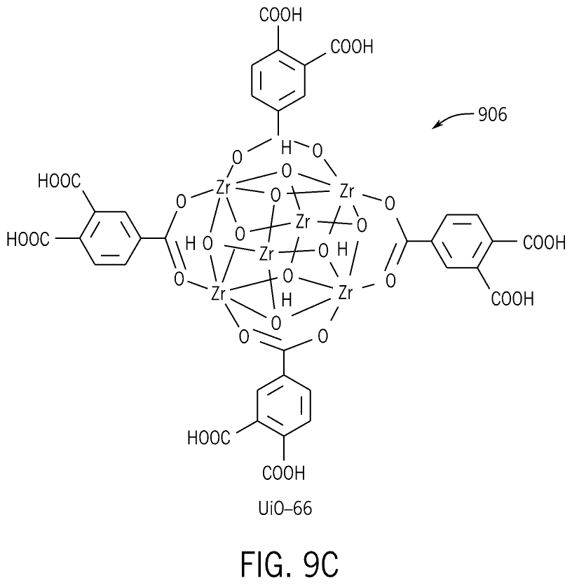

The example MOF coatings and composites described herein comprise one or more MOFs configured to capture gaseous fission products. In this regard, the example MOF coatings described herein may employ the additive functions of one or more MOFs, that is to be configured to capture each and every substance capable of being captured by each distinct MOF composition or type. For example, the various example MOF coatings described herein may include one or more MOFs configured to capture hydrogen containing gases and/or tritium containing gases (e.g., T₂, TF, and HF). In this regard and with reference to FIGS. 9A-9C, molecular structures of various example metal-organic frameworks that may be included in the MOF coatings are the present disclosure are shown. FIG. 9A illustrates an example molecular structure 902 of ZIF-4; FIG. 9B illustrates an example molecular structure 904 of ZIF-8; and FIG. 9C illustrates an example molecular structure 906 of UiO-66.

The MOF coatings described herein may include ZIF-4, ZIF-8, and/or UiO-66. However, the example MOF coatings described herein may include (additionally or alternatively) other MOFs known in the art. For example, the MOF coatings may include (individually, or in combinations) MOFs of the Coordination Framework from Augsburg (CFA) Family (e.g., CFA-2,CFA-10, and CFA-12), Hong Kong University of Science and Technology (HKUST) Family (e.g., HKUST-1), Matériaux de l'Institut Lavoisier (MIL) Family (e.g., MIL-57, and MIL-123), Molecular Sieve Versailles Santa Barbara (VSB) Family (e.g., VSB-5), Stonybrook Metal-Organic Framework (SBMOF) Family (e.g., SBMOF-1, and SBMOF-2), Ultralightweight Metal-Organic Framework (ULMOF) Family (e.g., ULMOF-1, ULMOF-2, and ULMOF-3), Universitet i Oslo (UiO) Family (e.g., UiO-66, and UiO-66-NH2), Zeolitic Imidazolate Framework (ZIF) Family (e.g., ZIF-4, ZIF-8, Cu-ZIF-8, ZIF-9, ZIF-11, and ZIF-12), and/or other MOFs known in the art.

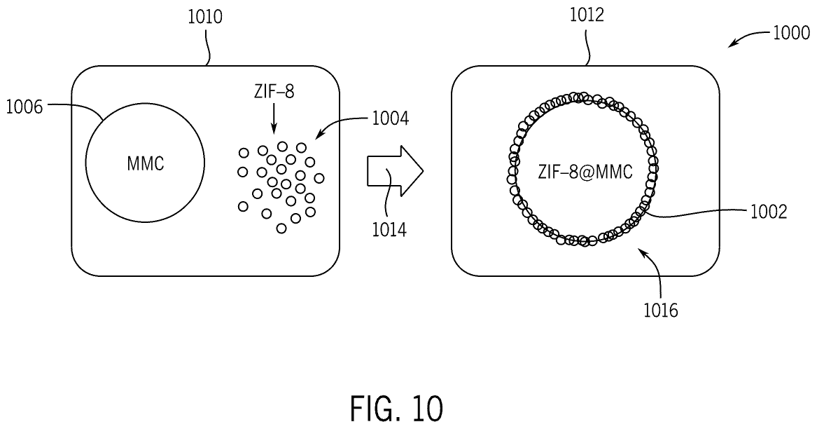

In at least one embodiment, the MOF coatings described herein may comprise a MOF composite, that is, one or more MOFs immobilized onto a substrate. In one embodiment, the MOF composite is a clay, gel, and/or paste-like substance capable of being spread over a surface of a reactor enclosure and/or vessel. In this regard, FIG. 10 illustrates a simplified synthesis scheme 1000 for a metal-organic framework composite.

Synthesis scheme 1000 illustrates a synthesis for a MOF composite 1002 comprising ZIF-8 1004 immobilized onto magnesium carbonate (“MMC”) 1006 in a core-shell structure. Synthesis scheme 1000 includes a preparation stage 1010 and a formation stage 1012. In the preparation stage 1010, MMC particles 1006 and ZIF-8 crystals 1004 are initially prepared or received and dispensed into a methanol solution. Thereafter, the reagents may undergo a mixing process 1014. In one example, the reagents (i.e., ZIF-8 1004 and MMC 1006) are simply physically mixed via agitation or stirring. However, mixing process 1014 may be accomplished via dispersion, sonication, incremental centrifugation, and the like. Following and/or during mixing process 1014, the ZIF-8 crystals 1004 attach to the MCC particles 1006 rending, at the formation stage 1012, a core-shell structure 1016 of ZIF-8@MMC 1002 (i.e., a MOF composite). As illustrated in FIG. 10, the core-shell structure 1016 generally includes the ZIF-8 1004 disposed on an exterior surface of MMC 1006, such that the MMC 1006 forms the “core” that is surrounded via a “shell” of ZIF-8. In the core-shell structure 1016, the inner mesoporous network of MMC 1006 acts as a backbone for the ZIF-8 1004 and would remain accessible through the micropores of the surrounding ZIF-8 1004. A core-shell structure 1016 may be advantageous to avoid moisture degradation of the MMC 1006. The MMC particles 1006 and ZIF-8 crystals 1004 may be pre-synthesized utilizing known methods. The MMC particles 1006 may be a mesoporous MMC with tunable pore structures. ZIF is a subcategory of MOFs composed of divalent transition metal cations (e.g., Zn, Co, Fe, etc.) tetrahedrally coordinated with imidazolate ligands. Advantageously, ZIFs provide thermal and chemical stability, allowing them to survive in an environment of an MSR system (i.e., at least 500° C.). Additionally, ZIF-8 may be capable of capturing (i.e., adsorbing or absorbing) tritium-containing gases such as T₂ and HF. The MOF composite 1002 may be a malleable clay or paste upon synthesis such that it can be spread across a surface. In one example, the MOF composite 1002 is further processed following synthesis in order to form it into a malleable clay or paste. Further processing may include combinations with other substances, heating, and/or cooling.

The MOF composite 1002 synthesized via synthesis scheme 1000 may be used in an MSR system (e.g., MSR system 100 and 200) to capture fission gases. In this regard, MOF composite 1002 may be utilized as a coating on enclosures and vessels to serve an additional layer of protection to prevent permeation of fission gases known to penetrate stainless steel. For example, MOF composite 1002 may be formed into a coating and disposed on the various surfaces of reactor enclosure 300 of FIG. 3 and/or the on the various surfaces of internal shielding vessel 400 of FIG. 4. Additionally or alternatively, MOF composite 1002 may be suspended into a headspace of a vessel of an MSR system to directly extract fission gases from salt-bearing components. As an example and with reference to FIG. 7, MOF composite 1002 may be disposed in cartridge 704 and suspended into headspace 750 via suspension assembly 710 in order to capture fission gases 754 present in vessel 752. Additionally or alternatively, MOF composite 1002 may be disposed as a filter within an off-gas system to capture potentially corrosive fission gases, thereby preventing damage to downstream components. As an example and with reference to FIG. 8, MOF composite 1002 may be disposed in isotope capture 822 within gas tank 820 of off-gas system 800 to capture fission gases entering off-gas system 800.

In one embodiment, the MOF coating may be formed into a clay or paste. For example, the MOFs may be dissolved in dihydrolevoglucosenone. This solvent may undergo self-polymerization via aldol condensation forming the MOF coating into a clay or paste.

In several embodiments, the MOF composite is generated via adding the metal salts and organic ligands of the MOF with the clay or paste material in solution during MOF formation. In this regard, the MOF and the clay may be formed simultaneously (e.g., within the same reaction mixture or solution) to generate the MOF composite into a clay or paste-like material. Example clay or paste materials include, but are not limited to, kaolin, bentonite, carbon paste electrode, and other cement-like materials.

In several embodiments as described herein, the MOF coating may be disposed or otherwise applied to one or more surfaces of one or more enclosures or vessels of an MSR system to capture gaseous fission products, such as tritium species, advantageously preventing their escape from the MSR system. In this regard, the MOF coating may comprise one or more MOFs immobilized onto the surface. In several embodiments, immobilization is facilitated by growing the MOF onto the surface or substrate of interest. For example, immobilization includes thermal solvolysis, where the metal surface is oxidized to form oxides (e.g., oxides, hydroxides, sulfates) and the metal salts and ligands of the MOF are assembled to form the MOF within a solution also containing the oxidized metal surface. In this example, the MOFs assembly together and anchor onto the metal surface. In some examples, the solution is heated to enhance production and yield of the chemical reaction. In other embodiments, the MOF is grown onto the surface or substrate of interest utilizing electrochemistry. In this embodiment, the metallic surface or substrate is used as an anode or cathode and upon application of electrical potential, the metallic surface or substrate is oxidized and thereby ready for anchoring by the MOFs. In some examples, the reaction includes submerging the electrode metallic surface or substrate in solution with the metal salts and ligands of the MOF so the MOF may grow and be incorporated into the metallic structure or substrate.

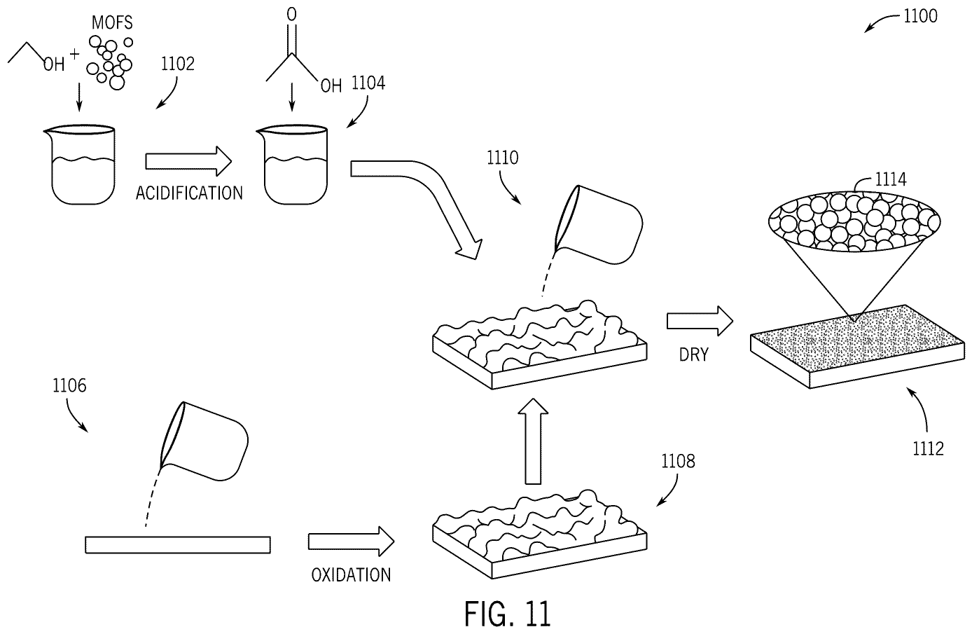

In several embodiments, immobilization is caused by pretreatment of the MOFs and pretreatment of the surface of the enclosure or vessel upon which the coating is applied. In several embodiments, pretreatment of the MOF comprises activating the MOF for adherence to the substrate or surface. For example, activation may include deprotonation of the MOF ligands by exposure to an acidic environment (or otherwise decrease the pH). In several embodiments, pretreatment of the substrate comprises oxidizing the surface prior to application. In this regard, FIG. 11 illustrates a simplified scheme 1100 for immobilizing the MOF coating onto a substrate.

In one embodiment, the MOF coating of the present disclosure is applied to the one or more surfaces of reactor enclosure 300 and/or internal shielding vessel 400 (as described with reference to FIGS. 3-6) according to scheme 1100. In one embodiment, the MOF coating of the present disclosure is integrated with the wire mesh 706 (as described with reference to FIG. 7) according to scheme 1100. In one embodiment, the MOF coating of the present disclosure is integrated with the isotope trap 822 (as described with reference to FIG. 8) according to scheme 1100. Generally, immobilization may be facilitated via ligand anchoring between deprotonated ligands of the MOFs and an oxidized surface of the substrate (e.g., reactor enclosure surface, reactor vessel surface, wire mesh, filter, etc.).

In one embodiment, at step 1102, one or more MOFs are dissolved in a solvent. In one embodiment, the solvent is a highly volatile solvent (e.g., ethanol, acetone, methanol, etc.). In other embodiments, at step 1102, the MOF reagents (e.g., the metal salts and organic ligands) are dissolved in a solvent (e.g., ethanol, acetone, methanol, etc.). Advantageously, a highly volatile solvent may aid in the drying step and ensure secure anchoring of the MOFs to the substrate. The one or more MOFs may include any one or of combination MOFs, or the reagents of the CFA Family (e.g., CFA-2, CFA-10, and CFA-12), the HKUST Family (e.g., HKUST-1), the MIL Family (e.g., MIL-57, and MIL-123), the VSB Family (e.g., VSB-5), the SBMOF Family (e.g., SBMOF-1, and SBMOF-2), the ULMOF Family (e.g., ULMOF-1, ULMOF-2, and ULMOF-3), the UiO Family (e.g., UiO-66, and UiO-66-NH2), the ZIF Family (e.g., ZIF-4, ZIF-8, Cu-ZIF-8, ZIF-9, ZIF-11, and ZIF-12), and/or other MOFs known in the art.

In one embodiment, at step 1104, the organic ligands are activated to encourage adherence to the surface or substrate of interest. In several embodiments, activation includes deprotonating the MOF ligands, for example by acidification of the MOF and solvent solution. In one embodiment, acetic acid is added to the solution, decreasing its pH. Advantageously, deprotonating the MOF ligands activates the ligands for bonding to the substrate. In one example, deprotonating facilitates ligand anchoring of the MOFs to the substrate. In other embodiments, activation includes protonating the MOF ligands. Depending on the pKa value of the MOF ligand and the pH of the solution, a given ligan may exist as its conjugated acid version or its conjugated vase version. In several embodiments, such reaction conditions are controlled to encourage ligand activation. Additionally, milder conditions may be used when utilizing MOFs that are vulnerable to very acidic and alkaline conditions. The ration of metal-to-ligands may be from about 50:1 to about 4:1.

At step 1106, the substrate to which the MOF coating will be applied is pretreated. In one embodiment, pretreatment includes oxidizing the substrate. For example, pretreatment may be effectuated via thermal solvolysis or electrochemical deposition. Oxidation may be effectuated via application of an acidic solution (e.g., 2 M HNO₃) to the substrate. In several embodiments, the substrate treated at step 1106 is the metallic surface of the reactor enclosure, internal shielding vessel, wire mesh, filter cartridge, and/or other surface described herein. At step 1108, the substrate may be allowed to try, leaving an oxidize surface for coating by the MOF and solvent solution.

At step 1110, the MOF solution (prepared at step 1104), now including MOFs with deprotonated ligands, and the substrate (prepared at step 1108), now having an oxidized surface, are combined. In several embodiments, the MOF solution is applied to the substrate by spin casting to effectuate an even film of MOF solution over the substrate. In other embodiments, the MOF solution may be sprayed, spread, brushed, dip-coated, or otherwise coated onto the substrate. In other embodiments, the substrate (prepared at step 1108) is immersed or submerged in the MOF solution or mother liquor (which contains the dissolved metal salts and activated ligands).

At step 1112, the MOF solution may be allowed to dry onto the substrate. In several embodiments, the highly volatile solvent quickly evaporates, leaving the MOFs applied as a coating over the substrate. Advantageously, at step 1112 the MOFs may be immobilized onto the substrate via ligand anchoring. In this regard, the deprotonated ligands may react with the oxidized surface, anchoring the two together (e.g., via hydrogen bonding or other intermolecular forces). In some examples, ligand anchoring may be driven by thermal conditions. In this regard, the MOF solution may be exposed to high temperatures to increase ligand anchoring.

In some embodiments, at step 1112, the substrate is heated to enhance the production yield of the chemical reaction.

As a result, the substrate may include a MOF coating (as described herein), the MOF coating may include a collection of MOFs 1114 immobilized onto the substrate. Advantageously, the MOF coating is configured to capture gaseous fission products contacting the substrate.

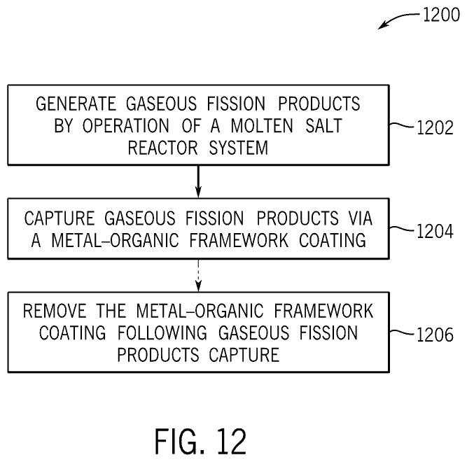

Turning now to FIG. 12, which illustrates a flow diagram of an example method 1200 for operating a nuclear reactor including capturing gaseous fission products. At step 1202, gaseous fission products are generated as a consequence of operation of a molten salt reactor system. For example, and with reference to FIG. 1, MSR system 100 may operate to generate heat via fission reactions occurring within the reactor vessel 102 (housing a reactor core). Said fission reactions may produce a wide variety of fission products (directly or indirectly), which may be in a gaseous form. Gaseous fission products may include tritium. These gaseous tritium species are known to penetrate and pass through stainless steel. The reactor enclosures and vessels of the various MSR systems described herein (e.g., those illustrated in FIGS. 1-4) may be at least partially composed of stainless steel.

At step 1204, gaseous fission products are captured via a MOF coating. The MOF coating may comprise one or more MOFs configured to capture gaseous fission products (e.g., T₂, TF, and/or HF) generated at step 1202. In several embodiments the MOF coating comprises a collection of one or more MOFs immobilized onto a substrate (e.g., stainless steel surfaces of MSR enclosures and/or vessels, as described herein). The one or more MOFs may be those illustrated in FIGS. 9A-9C but may also be any of the aforementioned MOFs disclosed herein (e.g., of the CFA family, HKUST family, MIL family, VSB family, SBMOF family, ULMOF family, UiO Family, and ZIF family). In one embodiment, the MOF coating is applied according to the scheme illustrated in FIG. 11. In one embodiment, the MOFs may be formed into a malleable clay or paste, allowing it to be spread across a surface. For example, and with reference to FIG. 3, the MOF composite may be disposed on any one of (or combination) surface 342, 344, 346, and/or 348, advantageously capturing gaseous fission products that may otherwise penetrate layers 332 and 336. As another example, and with reference to FIG. 4, the MOF coating may be disposed on any one of (or combination) surface 432, 434, 436, and/or 438 advantageously capturing gaseous fission products that may otherwise penetrate layers 406 and 408. As another example and with reference to FIG. 7, the MOF wire mesh 706 containing the MOF coating may be held within cartridge 704 and suspended into a headspace 750 of a salt-bearing vessel 752 via a suspension assembly 710. In this regard, the cartridge 704 may capture fission products as they diffuse from the molten fuel salt 756. As yet another example and with reference to FIG. 8, the substrate 824 containing the MOF coating may be disposed in an isotope trap 822 or filter within an off-gas system 800. In this regard, the substrate 824 may be disposed in gas tank 820 positioned upstream of one or more charcoal beds 806 and configured to capture corrosive fission product gases.

At step 1206, the MOF coating may be removed following fission product gas capture. For example, and with reference to FIG. 6, MOF coating 606, after a predetermined amount of time exposed to gaseous fission products, may be removed from surface 604 thereby extracting the captured fission products from the MSR system. As another example, and with reference to FIG. 7, cartridge 704 may be removed via suspension assembly 710 following a predetermined time disposed within headspace 750 thereby extracting the captured fission products from vessel 752. As yet another example, and with reference to FIG. 8, isotope trap 822 may be removed from gas tank 820 following a predetermined amount of time within the off-gas system thereby extracting the captured fission products off-gas system 800.

What is claimed is:

1. A fission gas capture system for a nuclear reactor comprising
a nuclear reactor system comprising at least one enclosure vessel, wherein the nuclear reactor system is operable to generate thermal energy via fission reactions; and
wherein the fission reactions generate gaseous fission products
a metal-organic framework coating disposed on a surface of the at least one enclosure vessel;
wherein the metal-organic framework coating is configured to capture the gaseous fission products.

2. The fission gas capture system of claim 1, wherein the metal-organic framework coating is immobilized on the surface via ligand anchoring.

3. The fission gas capture system of claim 2, wherein the metal-organic framework coating comprises at least one metal-organic framework selected from the group consisting of ZIF-4, ZIF-8, and UiO-66.

4. The fission gas capture system of claim 3, wherein the metal-organic framework coating is immobilized to the surface by
deprotonating ligands of the metal-organic framework;
dissolving the deprotonated metal-organic framework in a volatile solvent;
oxidizing a surface of the at least one enclosure vessel; and
drying the metal-organic framework on the surface

5. The fission gas capture system of claim 1, wherein the gaseous fission products comprise tritium.

6. The fission gas capture system of claim 1, wherein the metal-organic framework coating comprises at least one zeolitic imidazolate framework.

7. The fission gas capture system of claim 2, wherein the at least one enclosure vessel is an outer reactor enclosure vessel surrounding salt-bearing components of the nuclear reactor system.

8. The fission gas capture system of claim 2, wherein the at least one enclosure vessel is an internal shielding vessel surrounding a reactor vessel and a drain tank.

9. The fission gas capture system of claim 2, wherein the at least one enclosure vessel includes one or more distinct layers.

10. The fission gas capture system of claim 1, further comprising a suspension assembly coupled to a salt-bearing vessel of the nuclear reactor system operable to suspend a cartridge containing the metal-organic framework coating in the salt-bearing vessel.

11. The fission gas capture system of claim 10, wherein the suspension assembly comprises
an attachment rod coupled to the cartridge and extending into a headspace of the vessel;
a housing extending from the reactor access vessel encompassing the suspension assembly; and
an actuator operable to lower the cartridge into the headspace.

12. A reactor enclosure comprising
an enclosure vessel defining an inner volume and comprising one or more layers; and
wherein the inner volume is configured to house one or more salt-bearing components of a molten salt reactor system;
a metal-organic framework coating disposed over at least a portion of a surface of the one or more layers;
wherein the metal-organic framework coating is configured to capture fission product gases.

13. The vessel of claim 12, wherein the metal-organic framework coating comprises at least one metal-organic framework selected from the group consisting of ZIF-4, ZIF-8, and UiO-66.

14. The vessel of claim 13, wherein the metal-organic framework coating is immobilized on a metallic portion of the one or more layers via ligand anchoring between the at least one metal-organic framework and the metallic portion.

15. The vessel of claim 14, wherein the at least one metal-organic framework comprises deprotonated ligands.

16. The vessel of claim 12, wherein the enclosure encompasses the at least one salt-bearing component of the molten salt reactor system.

17. The vessel of claim 16, wherein the at least one salt-bearing component comprises
a reactor vessel including a reactor core;
a drain tank configured to store a molten salt;
a primary heat exchanger operable to facilitate heat transfer of the molten salt to a secondary salt; and/or
a reactor access vessel.

18. The vessel of claim 17, further comprising an internal shielding vessel disposed within the inner volume encompassing at least the reactor vessel and the drain tank.

19. An off-gas system comprising
an off-gas inlet pipe configured to receive an off-gas from a nuclear reactor system, the off-gas comprising fission products;
a first tank coupled to the off-gas inlet and configured to receive the off-gas; and
a second tank coupled to the first tank and configured to receive the off-gas from the first tank;
an isotope trap arranged within the first tank;
at least one charcoal bed arranged within the second tank;
wherein the isotope trap comprises at least one metal-organic framework configured to capture the fission products.

20. The off-gas system of claim 19, wherein the isotope trap further comprises a substrate, and wherein the at least one metal-organic framework is immobilized onto the substrate.

21. The off-gas system of claim 20, wherein the at least one metal-organic framework is configured to capture tritium.

22. The off-gas system of claim 20, wherein the metal-organic framework is selected from the group consisting of ZIF-8, ZIF-4, and UiO-66.

23. A method of operating a nuclear reactor comprising:
generating fission product gases by operating a molten salt reactor system;
wherein salt-bearing components of the molten salt reactor systems are enclosed within a reactor enclosure at least partially coated with a metal-organic framework coating; and
capturing the fission product gases via the metal-organic framework coating.

24. The method of claim 23, wherein the metal-organic framework coating is configured to capture hydrogen fluoride and tritium fluoride.

25. The method of claim 23, wherein the metal-organic framework coating is disposed on at least a portion of a surface of the reactor enclosure.

26. The method of claim 23, further comprising removing the metal-organic framework coating after the capturing, thereby removing captured fission product gases from the nuclear reactor.
